(19) United States
(12) Patent Application Publication
(10) Pub. No.: US 2025/0156422 A1
(43) Pub. Date: May 15, 2025

(54) SYSTEM, CACHE SERVER, METHOD, AND PROGRAM FOR PERFORMING PROCESSING RELATING TO RDB

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 19/024,567

(22) Filed: Jan. 16, 2025

Related U.S. Application Data
(63) Continuation of application No. PCT/JP2023/028150, filed on Aug. 1, 2023.

(30) Foreign Application Priority Data
Aug. 5, 2022 (JP) 2022-125757

(51) Int. Cl. G06F 16/2455; G06F 16/242

(52) U.S. Cl. CPC G06F 16/24552; G06F 16/242

(57) ABSTRACT

One or more embodiments of the invention is a system including a query generation unit that generates a predefined query that acts on a single row in a single table of a prescribed RDB, a query execution unit, and an object management unit. The query generation unit generates a query including cache identification information for identifying a cache object. The object management unit stores a cache object in a prescribed memory or deletes a cache object from the prescribed memory in prescribed cases. The query execution unit, in the case of executing a query including a select command, in the case where the cache identification information included in the query is stored in the prescribed memory, obtains the cache object associated with the cache identification information from the prescribed memory without executing the query on the prescribed RDB.

### TECHNICAL FIELD

The present invention relates to systems, cache servers, methods, and programs for performing processing relating to an RDB.

### BACKGROUND ART

Relational databases (RDBs) are used as database management systems in many services. Generally, query processing provided by an RDB is provided via SQL, which is a special programming language, which makes it possible to dictate extremely versatile and wide query processing. Thus, huge research and development efforts have been made for the optimization thereof (Non Patent Literature 1).

Recently, many games that are executed on terminal devices having communication functions, such as smartphones, have been released. In such game services, it is often the case that a database (RDB) is searched and updated at extremely high frequencies.

### CITATION LIST

### Non-Patent Literature

### NPL 1

Daniel Abadi, Anastasia Ailamaki, David Andersen, Peter Bailis, Magdalena Balazinska, Philip Bernstein, Peter Boncz, Surajit Chaudhuri, Alvin Cheung, AnHai Doan, Luna Dong, Michael J. Franklin, Juliana Freire, Alon Halevy, Joseph M. Hellerstein, Stratos Idreos, Donald Kossmann, Tim Kraska, Sailesh Krishnamurthy, Volker Markl, Sergey Melnik, Tova Milo, C. Mohan, Thomas Neumann, Beng Chin Ooi, Fatma Ozcan, Jignesh Patel, Andrew Pavlo, Raluca Popa, Raghu Ramakrishnan, Christopher Re, Michael Stonebraker, and Dan Suciu. 2020. The Seattle Report on Database Research. SIGMOD Rec. 48, 4 (December 2019), 44-53.

### SUMMARY OF INVENTION

### Technical Problem

Game systems are systems in which searching and updating of an RDB is required at high frequencies and in which only partial functions of a data manipulation language (DML) (e.g., the DML of SQL) are used. Generally, there are demands for improving speed and efficiency with processing relating to an RDB. In game systems that provide game services as well, it is an important issue to improve the speed and efficiency of processing relating to an RDB. It is conceivable that there is much room for realizing improved speed and improved efficiency of processing relating to an RDB in specific systems such as game systems, in which only partial functions of the DML are used and in which searching and updating of the RDB are required at high frequencies. However, a mechanism or system for realizing improved speed and improved efficiency has not been realized.

The present invention has been made in order to solve the problem described above, and it is an object thereof to provide a system, etc. that make it possible to realize improved speed or improved efficiency of processing in a specific system in which an RDB is searched or updated.

### Solution to Problem

[1]A system in one embodiment of the present invention is a system including:
a query generation unit that generates a predefined query that acts on a single row in a single table of a prescribed relational database, predefined queries including a query including an insert command, a query including a select command, and a query including a delete command;
a query execution unit that executes the query generated by the query generation unit; and
an object management unit that manages a cache object based on a query execution result obtained by the query execution unit as a result of executing the query,
wherein:
the query generation unit generates a query including cache identification information for identifying a cache object;
in the case where the query execution unit has obtained a query execution result as a result of executing the query including the insert command or the query including the select command, the object management unit stores the cache object based on the query execution result in a prescribed memory in association with the cache identification information included in the query executed, whereas in the case where the query execution unit has obtained a query execution result as a result of executing the query including the delete command, the object management unit deletes the cache object associated with the cache identification information included in the query including the delete command from the prescribed memory; and
in the case of executing the query including the select command, the query execution unit, in the case where the cache identification information included in the query is stored in the prescribed memory, obtains the cache object associated with the cache identification information from the prescribed memory without executing the query on the prescribed relational database.
[2]One embodiment of the present invention is a system according to [1], wherein:
the query generation unit generates a query in which query identification information generated on the basis of a given argument is added as a comment.
[3]One embodiment of the present invention is a system according to [2], wherein:
in the case where the query execution unit has obtained a query execution result as a result of executing the query including the insert command or the query including the select command, the object management unit does not store the cache object based on the query execution result in the prescribed memory in the case where the given argument satisfies a prescribed condition.
[4]One embodiment of the present invention is a system according to any one of [1] to [3], wherein:
the query generated by the query generation unit is an SQL query; and
the query generation unit generates a query including an INSERT command, a SELECT command, a SELECT FOR UPDATE command, an UPDATE command, or a DELETE command.
[5]One embodiment of the present invention is a system according to [4], wherein:
in the case where the query execution unit has obtained a query execution result as a result of executing a query including the UPDATE command, the object management unit deletes the cache object associated with the cache identification information included in the query from the prescribed memory.
[6]One embodiment of the present invention is a system according to any one of [1] to [5], wherein:
the prescribed memory is a memory or SSD storage of a cache server included in the system.
[7]One embodiment of the present invention is a system according to any one of [1] to [6], wherein:
the system includes a game server; and
the prescribed relational database is a relational database that stores information relating to a game.
[8]One embodiment of the present invention is a cache server including:
a query reception unit that receives, from a service providing server, a predefined query that acts on a single row in a single table of a prescribed relational database, predefined queries including a query including an insert command, a query including a select command, and a query including a delete command;
a query execution unit that executes the query received by the query reception unit; and
an object management unit that manages a cache object based on a query execution result obtained by the query execution unit as a result of executing the query,
wherein:
the query reception unit receives a query including cache identification information for identifying a cache object;
in the case where the query execution unit has obtained a query execution result as a result of executing the query including the insert command or the query including the select command, the object management unit stores the cache object based on the query execution result in a prescribed memory in association with the cache identification information included in the query executed, whereas in the case where the query execution unit has obtained a query execution result as a result of executing the query including the delete command, the object management unit deletes the cache object associated with the cache identification information included in the query including the delete command from the prescribed memory; and
in the case of executing the query including the select command, the query execution unit, in the case where the cache identification information included in the query is stored in the prescribed memory, obtains the cache object associated with the cache identification information from the prescribed memory without executing the query on the prescribed relational database.
[9]One embodiment of the present invention is a cache server according to [8], wherein:
the query generation unit generates a query in which query identification information generated on the basis of a given argument is added as a comment.
[10 ] One embodiment of the present invention is a method including:
a step of generating a predefined query that acts on a single row in a single table of a prescribed relational database, predefined queries including a query including an insert command, a query including a select command, and a query including a delete command;
a step of executing the query generated in the generating step; and
a step of storing or deleting a cache object based on a query execution result obtained by the query execution unit as a result of executing the query,
wherein:
the query generated in the generating step includes cache identification information for identifying a cache object;
the storing step, in the case where a query execution result has been obtained in the executing step as a result of executing the query including the insert command or the query including the select command, includes storing the cache object based on the query execution result in a prescribed memory in association with the cache identification information included in the query executed;
the deleting step, in the case where a query execution result has been obtained in the executing step as a result of executing the query including the delete command, includes deleting the cache object associated with the cache identification information included in the query including the delete command from the prescribed memory; and
the executing step, in the case of executing the query including the select command, in the case where the cache identification information included in the query is stored in the prescribed memory, includes obtaining the cache object associated with the cache identification information from the prescribed memory without executing the query on the prescribed relational database.
[11] One embodiment of the present invention is a method according to [10], wherein:
in the step of generating a query, a query in which query identification information generated on the basis of a given argument is added as a comment is generated.
[12] One embodiment of the present invention is a program for causing a computer to execute the steps of a method according to [10] or [11].

### Advantageous Effects of Invention

The present invention makes it possible to realize high speed or high efficiency of processing in a specific system that searches or updates an RDB.

### BRIEF DESCRIPTION OF DRAWINGS

FIG. 1 is an overall configuration diagram of an information processing system in one embodiment of the present invention.

FIG. 2 is a block diagram showing the hardware configuration of a service providing system in one embodiment of the present invention.

FIG. 3 is a functional block diagram of the service providing system in one embodiment of the present invention.

FIG. 4 is a figure showing a flowchart of processing by the service providing system in one embodiment of the present invention.

### Description of Embodiments

An information processing system 1 in an embodiment of the present invention will be described below with reference to the drawings. In this description, apps may mean apps installed on a smartphone or a tablet or may mean applications in general. In this description, there are cases where explanations that are more detailed than necessary are omitted for convenience of explanation.

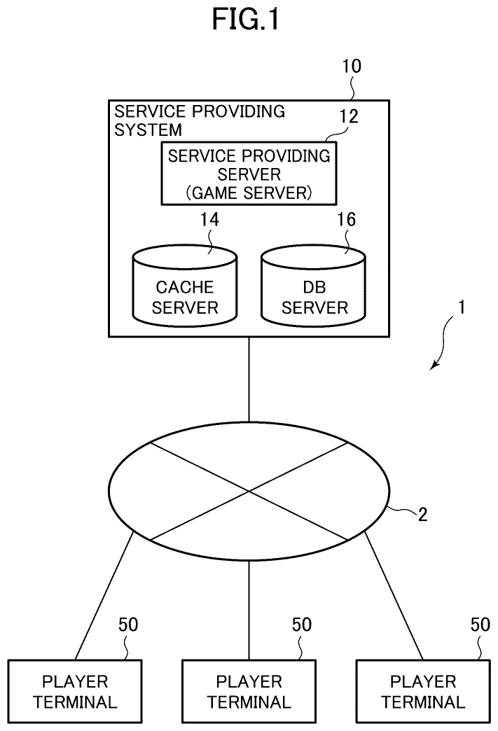

FIG. 1 is an overall configuration diagram of the information processing system 1 in one embodiment of the present invention. As shown in FIG. 1, the information processing system 1 includes a service providing system 10 and player terminals 50, and the service providing system 10 and the player terminals 50 are connected to a network 2 such as the Internet so as to be able to communicate with each other. Although the information processing system 1 in this embodiment will be explained assuming a known client-server system, there is no limitation thereto.

The service providing system 10 is a system configured to include one or more items of equipment. The service providing system 10 may be realized by a virtual machine or a cloud system. The service providing system 10 includes a service providing server 12, a cache server 14, and a database server (DB server) 16. The service providing server 12 is a game server or has the functionality of a game server. The service providing server 12 accepts accesses from the player terminals 50 and provides game services depending on players via the network 2. Therefore, in this embodiment, the service providing system 10 or the information processing system 1 is a game system. The cache server 14 is a server having the functionality of storing temporary data. The DB server 16 is a server having the functionality of storing permanent data and is a relational database that stores information relating to a game. In one example, the DB server 16 is a server implementing MySQL. In the following explanation, for convenience of explanation, it is assumed that the service providing system 10 is realized by a single item of equipment.

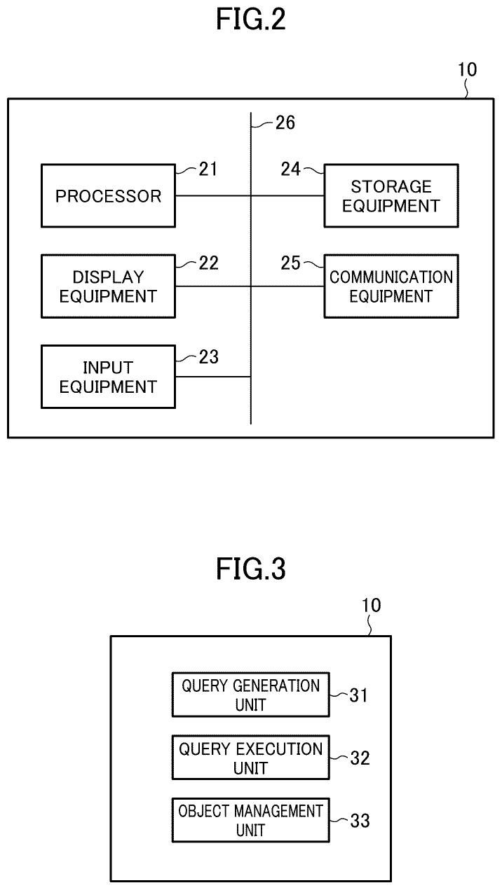

FIG. 2 is a block diagram showing the hardware configuration of the service providing system 10 in one embodiment of the present invention. The service providing system 10 includes a processor 21, input equipment 22, display equipment 23, storage equipment 24, and communication equipment 25. These individual constituent items of equipment are connected via a bus 26. It is assumed that interfaces are interposed as needed between the bus 26 and the individual constituent items of equipment.

The processor 21 controls the overall operation of the service providing system 10. The processor 21 is, for example, a CPU. The processor 21 executes various kinds of processing by loading programs and data stored in the storage equipment 24 and executing the programs. The processor 21 may be constituted of a plurality of processors.

The input equipment 22 is a user interface that accepts inputs to the service providing system 10 from a user, and the input equipment 22 is, for example, a keyboard or a mouse. The display equipment 23 is a display that displays application screens, etc. to the user of the service providing system 10 under the control of the processor 21.

The storage equipment 24 includes the cache server 14 or a program, data, and a storage area for realizing or the functionality of the cache server 14. The storage equipment 24 includes the DB server 16 or a program, data, and a storage area for realizing the functionality of the DB server 16. The storage equipment 24 may include main storage equipment and auxiliary storage equipment that are known.

The communication equipment 25 is a module, device, or equipment that is capable of transmitting data to and receiving data from other computers such as user terminals or servers via the network. The communication equipment 25 may be a device, a module, or the like for wireless communication, or may be a device, a module, or the like for wired communication.

The payer terminals 50 are smartphones used by players who use game services and may include the configuration of an ordinary smartphone. Alternatively, the player terminals 50 may be terminals such as personal computers or tablets. Each of the player terminals 50 includes processing equipment that controls individual units, such as a CPU, storage equipment including storage elements such as a ROM and a RAM, input and output equipment such as a touchscreen, and communication equipment such as a wireless module. These constituent elements are connected via a bus.

In this embodiment, each of the player terminals 50 has a game app AP1 installed therein, and the service providing server 12 has installed therein a server application AP2 corresponding to the game app AP1. When the game app AP1 is activated on the player terminal 50, the player terminal 50 communicates with the service providing server 12, and the service providing server 12 transmits and receives data necessary for the provision of a game service to and from the player terminal 50. In one example, while the game app AP1 is active at the player terminal 50, the service providing server 12 periodically or intermittently communicates with the player terminal 50 to execute a game in response to game operation inputs at the player terminal 50 and to transmit the results of the execution thereof to the player terminal 50. The service providing server 12 generates queries to obtain data such as game information from the DB server 16 as the game proceeds, or generates queries to store or delete data such as game information in or from the DB server 16 as the game proceeds. In one example, the service providing server 12 generates queries to store various kinds of game information in the DB server 16 in association with a player ID as the game proceeds.

FIG. 3 is a functional block diagram of the service providing system 10 in one embodiment of the present invention. The service providing system 10 includes a query generation unit 31, a query execution unit 32, and an object management unit 33. In this embodiment, these functions are realized by the processor 11 executing programs stored in the storage equipment 24. Since various functions are realized by loading programs, as described above, one part (function) may be provided in another part in part or in entirety. Alternatively, these functions may be realized by means of hardware by configuring an electronic circuit or the like for realizing each function in part or in entirety.

As the game proceeds, the service providing server 12 issues command statements for inserting data into, selecting data from, deleting data from, or updating data in the database (RDB) of the DB server 16. The query generation unit 31 generates such command statements, and in this embodiment, the query generation unit 31 generates predefined SQL queries (queries using prepared statements). The queries generated by the query generation unit 31 are predefined queries with which each single query acts on only a single row in a single table (single-table row-level locking (STRL) prepared statement). In this embodiment, the query generation unit 31 generates a predefined query that acts on only a single row in a single table, which is one of the following kinds of queries (command statements): an INSERT command, a SELECT command, a SELECT FOR UPDATE command, an UPDATE command, and a DELETE command. Therefore, the query generation unit 31 does not generate a query that acts on a plurality of rows in a single table, even if the query is a query of one of the following kinds: an INSERT command, a SELECT command, a SELECT FOR UPDATE command, an UPDATE command, and a DELETE command. Since a query includes a variable, a predefined query may mean a query of a predefined type.

The query execution unit 32 executes the query generated by the query generation unit 31. The query execution unit 32 can send the query generated by the query generation unit 31 to the DB server 16 to receive a query execution result from the DB server 16. It is assumed that the query execution result is a query execution result that is obtained when a query has been executed and the query is successful rather than resulting in an error or the like.

The object management unit 33 manages a cache object based on the query execution result obtained as a result of execution of a query by the query execution unit 32. In this embodiment, an object means data (query execution result) on a single row in a single table in the RDB, and therefore, a number of objects corresponding to the number of rows exist in a single table. A cache object serves to temporarily store an object, and is obtained by converting data of an object into data in a prescribed format (serialized object).

The query generation unit 31 generates a query including a cache ID for identifying a cache object. The cache ID is an example of cache object identification information that enables unique identification of a cache object. In this embodiment, as the game proceeds, the query generation unit 31 generates a query (a query using a prepared statement) including an INSERT command, a SELECT command, a SELECT FOR UPDATE command, an UPDATE command, or a DELETE command with which a single query acts on only a single row in a single table, the query further including information relating to a cache object corresponding to an object that is subject to the query.

In this embodiment, the query generation unit 31 generates a query having a cache ID assigned thereto as a comment, the cache ID being generated on the basis of some or all of given arguments (variables). For example, the arguments here are variable parts (elements) given to a query when the service providing server 12 sends a command statement for inserting data into, selecting data from, deleting data from, or updating data in the RDB of the DB server 16 as the game proceeds.

For example, the query generation unit 31 generates a query (a query using a prepared statement) such as the one given as example 1 below:

### (Example 1) INSERT INTO person (vid, name, param) VALUES ($1, $2, $3) --CacheID= “person $1 $2”

The query in example 1 is a command statement for adding a row including variables (elements) “$1, $2, $3” corresponding to individual columns in a table “person” including three columns “vid, name, param”. In the query in example 1, ‘CacheID= “person”_$1_$2”’ is the comment part, and “person_$1_$2” is the cache ID. In the query in example 1, “INSERT INTO. . . . VALUES. . . . -- CacheID=” including the command statement part “INSERT INTO. . . . VALUES” and the comment part “-- CacheID=” is one of the predefined queries. The names of tables included in the RDB, as well as information concerning columns included in the individual tables, are predefined. In the query in example 1, the table name “person” is used as the character string constituting the cache ID. “$1, $2, $3” is an expression representing the elements (values or character strings) corresponding to the individual columns as variables (variable parts). In the query in example 1, among the three elements “$1, $2, $3”, the two elements “$1, $2” are used as the character string constituting the cache ID. With this configuration, it becomes possible to automatically generate a cache ID that enables identification of data (object) on a single row in a single table in the RDB, and it also becomes possible to associate the object and a cache object via the cache ID.

The query execution unit 32 and the object management unit 33 perform processing corresponding to the type of query generated by the query generation unit 31. In this embodiment, five types of queries corresponding to basic functions (INSERT/SELECT/UPDATE/SELECT FOR UPDATE/DELETE) are assumed. Alternatively, queries based on the same basic function may be defined as different types of queries for individual tables to be referred to (in which the number of variables may vary).

In the case where the query generated by the query generation unit 31 is a query Q1 including the INSERT command, the query execution unit 32 sends the query Q1 to the DB server 16 and receives the result from the DB server 16. In the case where the query execution unit 32 has executed the query Q1 and has obtained a query execution result (in the case where the INSERT command is successful), the object management unit 33 converts the query execution result into a cache object and stores the cache object in a prescribed memory (cache area M) of the cache server 14 in association with the cache ID included in the query Q1 executed.

In the case where the query generated by the query generation unit 31 is a query Q2 including the SELECT command, the query execution unit 32 determines whether or not the cache ID included in the query Q2 is stored in the cache area M of the cache server 14.

In the case where the cache ID included in the query Q2 including the SELECT command is stored in the cache area M, the query execution unit 32 obtains the cache object associated with the cache ID from the prescribed memory. In this case, the query execution unit 32 does not execute the query Q2 with the DB server 16, that is, does not send the query Q2 generated by the query generation unit 31 to (does not query) the DB server 16. The query execution unit 32 can obtain a query execution result from the cache object obtained, the query execution result being obtained in the case where the query Q2 including the SELECT command has been executed. In the case where the cache ID included in the query Q2 is not stored in the cache area M, the query execution unit 32 sends the query Q2 to the DB server 16 and obtains the result from the DB server 16. In the case where the query execution unit 32 has executed the query Q2 and has obtained a query execution result (in the case where the SELECT command is successful), the object management unit 33 converts the query execution result into a cache object and stores the cache object in the cache area M in association with the cache ID included in the query Q2 executed.

In the case where the query generated by the query generation unit 31 is a query Q3 including the DELETE command, the query execution unit 32 sends the query Q3 to the DB server 16 and obtains the result from the DB server 16. In the case where the query execution unit 32 has executed the query Q3 including the DELETE command and has obtained a query execution result (in the case where the DELETE command is successful), the object management unit 33 deletes the cache object associated with the cache ID included in the query Q3, stored in the cache area M of the cache server 14, from the cache area M together with the cache ID.

In the case where the query generated by the query generation unit 31 is a query Q4 including the SELECT FOR UPDATE command, the query execution unit 32 sends the query Q4 to the DB server 16 and obtains the result from the DB server 16. During the execution of the SELECT FOR UPDATE command, the object subject to the query Q4 is temporarily locked, and the object management unit 33 temporarily locks the cache object associated with the cache ID included in the query Q4. Note that while the object subject to the query Q4 is locked, writing to and locking of the object from other queries are blocked. Furthermore, upon the completion of processing for the query Q4, the object subject to the query Q4 is unlocked, and the cache object associated with the cache ID included in the query Q4 is also unlocked.

In the case where the query generated by the query generation unit 31 is a query Q5 including the UPDATE command, the query execution unit 32 sends the query Q5 to the DB server 16 and obtains the result from the DB server 16. During the execution of the UPDATE command, the object subject to the query Q5 is temporarily locked, and the object management unit 33 temporarily locks the cache object associated with the cache ID included in the query Q5 executed. In the case where the query execution unit 32 has executed the query Q5 including the UPDATE command and has obtained a query execution result (in the case where the UPDATE command is successful) and in the case where the cache ID included in the query Q5 is stored in the cache area M of the cache server 14, the object management unit 33 deletes the cache object associated with the cache ID from the cache area M together with the cache ID. Note that while the object subject to the query Q5 is locked, writing to and locking of the object from other queries are blocked. Furthermore, upon the completion of processing for the query Q5, the object subject to the query Q5 is unlocked, and the cache object associated with the cache ID included in the query Q5 is also unlocked.

In this embodiment, the cache server 14 functions as a proxy server that requests a query, the service providing server 12 has the functionality of the query generation unit 31, and the cache server 14 includes the query execution unit 32 and the object management unit 33. The cache server 14 includes a query reception unit that receives a query generated by the service providing server 12. The cache server 14 (the query execution unit 32) passes a query execution result obtained as a result of the received query to the service providing server 12. However, which constituent element (equipment, system, or the like) includes which functional unit of the service providing system 10 is not limited to the above configuration as long as there is no departure from the gist of the invention. For example, the configuration may be such that the service providing server 12 includes the query generation unit 31, the query execution unit 32, and the object management unit 33 and such that the cache server 14 only has the functionality of temporarily storing data in a prescribed memory.

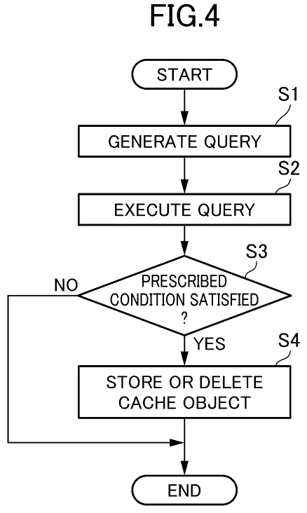

FIG. 4 is a figure for explaining an example flowchart of processing by the service providing system 10 in one embodiment of the present invention.

In step S1, the query generation unit 31 generates a query. In this embodiment, the query generation unit 31 generates a query including the INSERT command, the SELECT command, the SELECT FOR UPDATE command, the UPDATE command, or the DELETE command, which acts on only a single row in a single table of the RDB of the DB server 16. Regarding the following steps, processing will be described individually for each type of query.

In the case where the query generated by the query generation unit 31 is the INSERT command, in step S2, the query execution unit 32 sends the query to the DB server 16 to execute the query. In step S3, the query execution unit 32 determines whether or not the query executed is successful, i.e., whether or not a query execution result has been normally obtained from the DB server 16 (e.g., whether or not an error message has occurred or not). The flowchart proceeds to step S4 when the query is successful, whereas the flowchart comes to an end when the query is not successful. In step S4, the object management unit 33 converts the query execution result obtained by the query execution unit 32 into a cache object, and stores the cache object in a prescribed memory (cache area M) of the cache server 14 in association with the cache ID included in the query executed in step S2.

In the case where the query generated by the query generation unit 31 is the SELECT command, in step S2, the query execution unit 32 determines whether or not the cache area M of the cache server 14 stores the cache ID included in the query. The query execution unit 32 obtains the cache object associated with the cache ID from the cache area M in the case where the cache area M stores the cache ID included in the query, while sending the query to the DB server 16 in the case where the cache area M does not store the cache ID.

In step S3, the query execution unit 32 determines whether or not the query executed is successful in the case where the query has been sent to the DB server 16. The flowchart proceeds to step S4 when the query is successful, whereas the flowchart comes to an end in the case where the query has not been sent to the DB server 16 or when the query is not successful. In step S4, the object management unit 33 converts the query execution result obtained by the query execution unit 32 into a cache object, and stores the cache object in the cache area M in association with the cache ID included in the query executed in step S2.

In the case where the query generated by the query generation unit 31 is the DELETE command, in step S2, the query execution unit 32 sends the query to the DB server 16 to execute the query. In step S3, the query execution unit 32 determines whether or not the query executed is successful. The flowchart proceeds to step S4 when the query is successful, whereas the flowchart comes to an end when the query is not successful. In step S4, in the case where the cache object associated with the cache ID included in the query executed in step S2 is stored in the cache area M, the object management unit 33 deletes the cache object together with the cache ID from the cache area M.

In the case where the query generated by the query generation unit 31 is the UPDATE command, in step S2, the query execution unit 32 sends the query to the DB server 16 to execute the query. In step S3, the query execution unit 32 determines whether or not the query executed is successful. The flowchart proceeds to step S4 when the query is successful, whereas the flowchart comes to an end when the query is not successful. In step S4, in the case where the cache object associated with the cache ID included in the query executed in step S2 is stored in the cache area M, the object management unit 33 deletes the cache object together with the cache ID from the cache area M.

In the case where the query generated by the query generation unit 31 is the SELECT FOR UPDATE command, in step S2, the query execution unit 32 sends the query to the DB server 16 to execute the query. Since the SELECT FOR UPDATE command does not result in changing any object, the SELECT FOR UPDATE command does not result in storing or deleting any cache object. Thus, the flowchart comes to an end in the case where the query executed in step S2 is the SELECT FOR UPDATE command in step S3.

Next, the main operations and advantages of the service providing system 10 (information processing system 1) in the embodiment of the present invention will be described.

It has hitherto been an important issue in game systems to improve the speed, efficiency, and reliability of existing RDBs, including caches and the data access layer constituting peripheral software. In particular, improving the query cache mechanism, which has become indispensable in use cases of RDBs, is an important issue since the improvement may lead to improvement in the overall performance of the server-side system. A query cache refers to a mechanism for saving the result of a query once executed in a memory and returning the data stored in the memory without executing the query for the second time on an RDB, thereby improving the response speed of the overall system while reducing the load of the database. The query cache is designed for general purposes so as to be applicable to substantially any application and is not optimized for any SQL use case.

The embodiment of the present invention is based on the fact that for the purpose of database queries during ordinary operation of a game, only queries with which a single query acts on only a single row in a single table are used. In this embodiment, each query generated by the query generation unit 31 is a query with one of the INSERT command, the SELECT command, the SELECT FOR UPDATE command, the UPDATE command, and the DELETE command, which is a query using a prepared statement and which acts on only a single row in a single table. As described above, the arrangement is such that all the queries to the RDB of the DB server 16 during game operation of the game server (the service providing server 12) are queries of the type mentioned above. Furthermore, in this embodiment, when generating a query, the query generation unit 31 automatically generates a character string that enables identification of a cache object on the basis of a query parameter that enables identification of the object and assigns the character string as an annotation comment. Furthermore, in this embodiment, for each query type (INSERT/SLECT/UPDATE (SELECT FOR UPDATE)/DELETE), the object management unit 33 manages locking and life of a cache object when the query is executed.

With this configuration, it is possible to improve the query cache mechanism of an RDB in a game system, and it is possible to unitarily and automatically manage association between a cache object and the RDB as well as the life of the cache object. This makes it possible to realize improvements in the speed and efficiency of processing in the game system.

Furthermore, by performing such automatic cache object management, it becomes possible to control the life of a cache object independently of applications. Accordingly, it becomes possible for the cache server 14 to store objects in the RDB as cache objects and to realize a distributed memory cache system. Furthermore, since it is possible to implement, on the cache server 14, a function for transparently converting all entries (all objects) in the RDB into object data representations specific to a programming language (e.g., PHP or C#), it is possible to realize a “distributed on-memory serialized object cache”. Accordingly, it becomes possible to safely and efficiently implement a cache layer in a server-side program for which a plurality of engineers perform coding. In this case, the data structure of a cache object stored in the cache server 14 is a serialized object, where the serialized object refers to a binary data representation used when externally storing a data structure adopted in a programming language.

As described earlier, in the embodiment of the present invention, all queries are defined in advance and can be implemented as prepared statements. Thus, when the cache server 14 in this embodiment is activated, the cache server 14 can execute all the prepared statements with the SELECT command by using parameters within the range of the player IDs that the cache server is in charge of and can store data (objects) of individual rows in the tables corresponding to the SELECT command in the RDB as serialized objects. There has been no such technology for existing web apps or cloud apps.

The operations and advantages described above also apply to other embodiments and modifications unless otherwise specifically mentioned.

A system in an embodiment of the present invention may be the information processing system 1 or the service providing system 10. In one or more embodiments of the present invention, the service providing system 10 need not include the DB server 16. In this embodiment, the DB server 16 is configured to be able to communicate with the service providing system 10. Furthermore, in an embodiment in which the cache server 14 does not function as a proxy server and has only the functionality for temporary storage in a cache area, the service providing system 10 need not include the cache server 14. In this embodiment, the cache server 14 is configured to be able to communicate with the service providing system 10. Furthermore, in this embodiment, the service providing system 10 can be realized by the service providing server 12.

In one or more embodiments of the present invention, the present invention may be applied to a system that provides a prescribed service other than a game system that generates and executes queries using prepared statements with which a single query acts on only a single row in a single table. In this embodiment, the service providing server 12 may be an application server that provides the prescribed service other than a game service, or may have the functionality of an application server. In this embodiment, the service providing server 12 is not a game server and does not have the functionality of a game server.

In one or more embodiments of the present invention, in the case where the individual functional units of the service providing system 10 described above are capable of executing similar operations, the language for queries generated by the query generation unit 31 and executed by the query execution unit 32 may be a language other than SQL. For example, it suffices for the query language to include an insert command corresponding to the INSERT command, a select command corresponding to the SELECT command, an exclusive lock command corresponding to the SELECT FOR UPDATE command, an update command corresponding to the UPDATE command, and a delete command corresponding to the DELETE command.

In one or more embodiments of the present invention, the query generation unit 31 may be configured to generate a predefined query that is a query including one of the INSERT command, the SELECT command, and the DELETE command and that acts on only a single row in a single table. In one or more embodiments of the present invention, the query generation unit 31 may be configured to generate a predefined query that is a query including one of the INSERT command, the SELECT command, the UPDATE command, and the DELETE command and that acts on only a single row in a single table. In one or more embodiments of the present invention, the query generation unit 31 may be configured to generate a predefined query that is a query including one of the INSERT command, the SELECT command, the SELECT FOR UPDATE command, and the DELETE command and that acts on only a single row in a single table.

In one or more embodiments of the present invention, the object management unit 33 may be configured such that, in the case where a given argument satisfies a prescribed condition, even in the case where the query execution unit 32 has executed a query including the INSERT command or the SELECT command and has obtained a query execution result, the object management unit 33 does not convert the query execution result into a cache object. Therefore, in this case, the object management unit 33 does not store a cache object in the cache area M of the cache server 14. In one example, the query generation unit 31 can generate a query in which a prescribed condition is added as a comment.

For example, the query generation unit 31 generates a query (a query using a prepared statement) given as example 2 below.

### (Example 2) INSERT INTO person (vid, name, param) VALUES ($1,$2, $3) -- CacheID= “person_$1 $2”, Ignore =$1 lt 0

The query in example 2 is obtained by adding a prescribed condition “Ignore =$1 lt 0”. This prescribed condition specifies that “$1” be less than zero. In this case, the object management unit 33 does not store a cache object in the cache area M in the case where “$1” is less than zero. Various operators can be implemented as comparison operators, such as less-than (lt), greater-than (gt), equal (eq), partially equal (pe), AND, OR, and NOT.

In one or more embodiments of the present invention, the cache server 14 can store serialized objects in a prescribed memory or SSD storage of the cache server 14 as a single file per single object. In one example, in the case where PHP is used to implement an application server that executes game logic on the server side (the service providing server 12), the cache server 14 stores serialized objects as those in PHP. In one example, in the case where C# is used to implement an application server (the service providing server 12), the cache server 14 stores serialized objects in the Protocol Buffers format, which is the easiest to handle in C#. As described above, the format of serialized objects may vary among individual programming languages for dictating an application.

In one or more embodiments of the present invention, a cache object may be object data itself. In this embodiment, obtaining a cache object means obtaining a query execution result.

In an embodiment of the present invention, the player terminal 50 may be configured to receive downloadable data from the service providing server 12 in advance before the player plays the game and to store the data as data relating to the game app AP1. In this case, the player terminal 50 has functions necessary for realizing the game service except functions that have to be implemented in the service providing server 12, such as updating data relating to the player. Alternatively, the player terminal 50 may be configured as a thin client terminal for input/output. In this case, the service providing server 12 has functions necessary for realizing the game service except input/output functions at the player terminal 50.

As described above, an embodiment of the present invention may be the information processing system 1 or the service providing system 10. An embodiment of the present invention may also be the cache server 14 including the query execution unit 32 and the object management unit 33. An embodiment of the present invention may also be a program for realizing the functions or the information processing shown in the flowchart in the above-described embodiment of the present invention, or a computer-readable storage medium storing the program. Alternatively, an embodiment of the present invention may also be a method for realizing the functions or the information processing shown in the flowchart in the above-described embodiment of the present invention. Alternatively, an embodiment of the present invention may also be a server that is capable of providing a computer with a program for realizing the functions or the information processing shown in the flowchart in the above-described embodiment of the present invention.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 Information processing system
2 Network
10 Service providing system
12 Service providing server
14 Cache server
16 Database server
21 Processor
22 Display equipment
23 Input equipment
24 Storage equipment
25 Communication equipment
26 Bus
31 Query generation unit
32 Query execution unit
33 Object management unit
50 Player terminal

1. A system comprising:
a query generation unit that generates a predefined query that acts on a single row in a single table of a prescribed relational database, predefined queries including a query including an insert command, a query including a select command, and a query including a delete command;
a query execution unit that executes the query generated by the query generation unit; and
an object management unit that manages a cache object based on a query execution result obtained by the query execution unit as a result of executing the query,
wherein:
the query generation unit generates a query including cache identification information for identifying a cache object;
in the case where the query execution unit has obtained a query execution result as a result of executing the query including the insert command or the query including the select command, the object management unit stores the cache object based on the query execution result in a prescribed memory in association with the cache identification information included in the query executed, whereas in the case where the query execution unit has obtained a query execution result as a result of executing the query including the delete command, the object management unit deletes the cache object associated with the cache identification information included in the query including the delete command from the prescribed memory; and
in the case of executing the query including the select command, the query execution unit, in the case where the cache identification information included in the query is stored in the prescribed memory, obtains the cache object associated with the cache identification information from the prescribed memory without executing the query on the prescribed relational database.

2. The system according to claim 1, wherein the query generation unit generates a query in which query identification information generated on the basis of a given argument is added as a comment.

3. The system according to claim 2, wherein in the case where the query execution unit has obtained a query execution result as a result of executing the query including the insert command or the query including the select command, the object management unit does not store the cache object based on the query execution result in the prescribed memory in the case where the given argument satisfies a prescribed condition.

4. The system according to claim 1, wherein:
the query generated by the query generation unit is an SQL query; and
the query generation unit generates a query including an INSERT command, a SELECT command, a SELECT FOR UPDATE command, an UPDATE command, or a DELETE command.

5. The system according to claim 4, wherein in the case where the query execution unit has obtained a query execution result as a result of executing a query including the UPDATE command, the object management unit deletes the cache object associated with the cache identification information included in the query from the prescribed memory.

6. The system according to claim 1, wherein the prescribed memory is a memory or SSD storage of a cache server included in the system.

7. The system tem according to claim 1, wherein:
the system includes a game server; and
the prescribed relational database is a relational database that stores information relating to a game.

8. A cache server comprising:
a query reception unit that receives, from a service providing server, a predefined query that acts on a single row in a single table of a prescribed relational database, predefined queries including a query including an insert command, a query including a select command, and a query including a delete command;
a query execution unit that executes the query received by the query reception unit; and
an object management unit that manages a cache object based on a query execution result obtained by the query execution unit as a result of executing the query,
wherein:
the query reception unit receives a query including cache identification information for identifying a cache object;
in the case where the query execution unit has obtained a query execution result as a result of executing the query including the insert command or the query including the select command, the object management unit stores the cache object based on the query execution result in a prescribed memory in association with the cache identification information included in the query executed, whereas in the case where the query execution unit has obtained a query execution result as a result of executing the query including the delete command, the object management unit deletes the cache object associated with the cache identification information included in the query including the delete command from the prescribed memory; and
in the case of executing the query including the select command, the query execution unit, in the case where the cache identification information included in the query is stored in the prescribed memory, obtains the cache object associated with the cache identification information from the prescribed memory without executing the query on the prescribed relational database.

9. The cache server according to claim 8, wherein the query generation unit generates a query in which query identification information generated on the basis of a given argument is added as a comment.

10. A method comprising:
a step of generating a predefined query that acts on a single row in a single table of a prescribed relational database, predefined queries including a query including an insert command, a query including a select command, and a query including a delete command;
a step of executing the query generated in the generating step; and
a step of storing or deleting a cache object based on a query execution result obtained in the executing step as a result of executing the query,
wherein:
the query generated in the generating step includes cache identification information for identifying a cache object;
the storing step, in the case where a query execution result has been obtained in the executing step as a result of executing the query including the insert command or the query including the select command, includes storing the cache object based on the query execution result in a prescribed memory in association with the cache identification information included in the query executed;
the deleting step, in the case where a query execution result has been obtained in the executing step as a result of executing the query including the delete command, includes deleting the cache object associated with the cache identification information included in the query including the delete command from the prescribed memory; and
the executing step, in the case of executing the query including the select command, in the case where the cache identification information included in the query is stored in the prescribed memory, includes obtaining the cache object associated with the cache identification information from the prescribed memory without executing the query on the prescribed relational database.

11. The method according to claim 10, wherein in the step of generating a query, a query in which query identification information generated on the basis of a given argument is added as a comment is generated.

12. A non-transitory computer readable medium storing a program for causing a computer to execute the steps of a method according to claim 10.
